(19) United States
(12) Patent Application Publication
(10) Pub. No.: US 2001/0037314 A1
(43) Pub. Date: Nov. 1, 2001

(54) System, method and apparatus for authenticating the distribution of data

(76) Inventor: Mark M. Ishikawa, San Jose, CA (US)

Correspondence Address: BRULL PICCIONELLI SARNO BRAUN & VRADENBURGH, Suite 2350, 1925 Century Park East, Los Angeles, CA, 90067, US

(21) Appl. No.: 09/821,259

(22) Filed: Mar. 29, 2001

Related U.S. Application Data
(60) Provisional application No. 60/193,653, filed on Mar. 30, 2000.

(51) Int. Cl. G06F 17/60

(52) U.S. Cl. 705/67

(57) ABSTRACT

Embodiments of the present invention are directed to a system, method and apparatus for a data distribution and request authentication system. In embodiments of the present invention, the data authentication system couples a confirmation code with the distribution of data, such as an advertising link, and compares the confirmation code to known data upon a response to the distributed data, for example, linking to a merchant's web site via the advertising link.

### RELATED APPLICATIONS

This application claims priority from provisional patent application, Ser. No. 60/193,653 filed Mar. 30, 2000, entitled “System, Method and Apparatus For Authenticating The Distribution of Advertisements”, which is fully incorporated herein by reference.

### FIELD OF THE INVENTION

This invention is directed to a system, method and apparatus for a data request and distribution authentication system. More specifically, the data authentication system couples a confirmation code with the distribution of data, such as an advertising link, and compares the confirmation code to known data upon a response to the distributed data, for example, linking to a merchant's web site via the advertising link.

### BACKGROUND OF THE INVENTION

Advertising on wide area networks, such as, the World Wide Web (“WWW”) or the Internet, allows advertisers and merchants to globally market goods and services. Currently, portions of advertisements are presented to users via banners on web pages. Typically, the banners reside on a designated portion of the web page, such as, along the top, side(s) or along the bottom of the page. Upon the viewing of a banner, an interested user need only ‘click’ onto the banner to access the full advertisement or sales page.

In more traditional modalities of advertising, a merchant desiring to “place an ad”, contracts with an advertiser for a predefined amount of time on radio or television, or space on a print page. The amount of time that the advertisement will be presented to consumers and the locations of the distribution of the advertisement determine, in part, the price of the advertisement. Thus, an advertisement placed in a local newspaper for a week would most likely cost considerably less than an advertisement placed in a nationally distributed newspaper for that same amount of time. Similarly, advertisements on television stations that are limited in broadcast are typically less expensive than an advertisement on a station that is broadcast via satellite over a larger geographic area. In all of these instances, the merchant is fairly well informed of the type and size of audience that may view the advertisement. Thus, the fee can be more readily negotiated as some of the more pertinent information regarding the parameters of the service being provided is readily available.

Unlike more traditional advertising modalities, advertising on a global network, such as, the Internet, does not readily provide the type of information upon which to base a fee for advertising between a merchant and advertiser. Indeed, although the advertisement is potentially distributed on a global basis, global distribution may be of no benefit to the merchant. Indeed, an advertisement for local goods or services, which is distributed on a global basis, is of relatively little value to a local merchant. Further still, global distribution does not guarantee that the advertisement will be viewed by a particular type of market or target audience. Thus, in attempting to access the value of the service being provided to the merchant, the more traditional factors do not readily reflect a value that can be translated into a monetary fee.

One attempt to solve this apparent value for service problem is to pay the advertiser based on the number of ‘clicks’ on the advertisement or upon performance by the user of predefined activity, such as, purchasing the advertised product or filling out a questionnaire, or having a particular advertisement viewed by the user. In this instance, the merchant pays only for the number of people who click on the advertisement or perform the desired behavior after accessing the advertisement.

Although this method of payment provides some solution to the problem of determining a fee for the distribution of the advertisement, it presents certain problems. For instance, without collecting user data, a merchant does not know what type of consumer is viewing the advertisement. Nonetheless, this issue is present in traditional advertising as well, and it is only through the collection of user data that the profile of the audience can be defined or parameterized.

Further, a seemingly unqualified consumer, that is, a consumer who is not likely to purchase the goods or services, may click on the advertisement from curiosity. However, this type of ‘false’ click is acceptable as it may translate into an interested consumer, and further still, is typically not so excessive that the benefits of the fee per click are outweighed.

Probably the most egregious problem is that of advertiser fraud through the generation of fraudulent clicks. As stated above, in traditional advertising modalities, as both the advertiser and the merchant can approximate the potential audience size, the fee is typically fixed. In contrast, a fee per click/activity payment method provides a greater incentive to the advertiser to place the advertisement in front of as many consumers as possible, regardless of the consumer's market profile. Thus, advertisers are motivated to increase the number of clicks/activity on each advertisement.

One method of increasing apparent clicks or viewing of an advertisement is to send the advertisement as an email. As each individual user retrieves their email, the advertisement containing the link, or the link alone, is displayed. If the user clicks on the advertisement or the link, some activity occurs to the advertisement site or sales page, such as, the user being transferred to the advertisement site or sales page. The clicking by the user on the advertisement or link causes the count of the clicks, that is, the number of responses, for the advertisement to be increased as the counter does not, and cannot, differentiate as to the manner in which the request to view the full advertisement is made, for example, through an email or on a web site page. As it is possible to send hundreds of thousands of emails at once, if all of the users who receive the advertisement or link in email, click on the advertisement or link, and, if clicking is the only criteria for payment, the fee due the advertiser can become an exorbitant amount. Although this may lead to some sales, it is problematic in that most of the audience of the advertising link is not a target audience. Thus, the merchant will, most likely, pay disproportionate advertising costs in relationship to the number of sales.

In addition to the generation of fraudulent fees, the advertiser further subjects the merchant to complaints for violations of law, and loss of business. Currently, laws exist that prohibit the sending of unsolicited emails, commonly referred to as spamming. Thus, the “bulk” emailing of the advertiser can be deemed to violate anti-spam laws and can potentially subject the merchant to third-party actions. As every advertisement includes an advertiser identification code, which identifies a specific advertiser, it is possible for the merchant to prove that he did not send the unsolicited email. However, the consumer is not likely to be advised of this fact or discern it on his own; rather, the consumer will simply refuse to purchase goods or services from the merchant, and in some instances, inform others of the annoying and undesirable business practice.

Currently, when a user clicks on an advertisement, or a link, some activity occurs, such as a transference of the user to the merchant's web page, where the full advertisement or sales page resides. In addition to the activity, for example, the transmission of the user to the web page, user information generated in accordance with standard transmission protocols and the advertiser's identification is also transmitted. The transmission of the advertiser's identification allows the merchant to identify which advertiser referred the user. In this manner, the merchant is able to count the number of clicks generated by a particular advertiser so that the advertiser can be appropriately paid for each advertisement. Indeed, merchants often utilize more than one source or advertiser, and thus, must be able to appropriately credit and assess which advertising modality is effective. As the merchant is currently only counting the number of clicks on the advertisement, if the clicks on the advertisement are the result of advertiser fraud, such as, “bulk emails”, the merchant is unable to identify the click as resulting from a fraudulent advertising scheme and the advertiser is inappropriately paid. As stated above, in addition to the payment of fraudulent fees, the merchant can be subjected to legal action and loss of good will of the business. A need in the industry exists for a manner of authenticating responses to advertisements and the distribution modality of those advertisements. A further need exists for more accurately accessing the effectiveness of an advertising modality.

### SUMMARY OF THE DISCLOSURE

Embodiments of the present invention are directed to a system, method and apparatus for a data request and distribution authentication system. More specifically, embodiments of the present invention are directed to a method for differentiating between fraudulently generated clicks on an advertisement and genuine consumer generated clicks.

In embodiments of the present invention, the data authentication system couples a confirmation code with the distribution of data, such as an advertising link, and compares the confirmation code to known data upon a response to the distributed data, for example, linking to a merchant's web site via the advertising link. The confirmation code comprises an advertiser's identification code and a dynamically generated user identification code. The user identification code is coupled to, or encrypted into, the advertiser identification, thereby generating the confirmation code, or an encrypted advertiser's identification.

When an advertising link is loaded onto a user's computer, a confirmation code is generated. If the user chooses to access the advertised materials, for example, the web page being advertised, the user clicks on the advertising link and is transmitted to the merchant's web site. As the user is transmitted to the merchant's web page, current user information generated in accordance with standard transmission protocols and the confirmation code are also transmitted.

Upon receipt of the request for information from the user, the merchant compares the current user information to aspects of the confirmation code, namely, the user identification code generated dynamically at the time the advertising link was loaded onto the user's computer. If the current user information matches the previously generated user identification code, or the confirmation code can otherwise be verified, the entry is recorded in a logging database file for the advertiser associated with the advertising link. Once the information is recorded in the merchant's advertiser log, the entry is further passed to an accounting management system, which tracks the amount of remuneration owed to each advertiser. If the user identification code does not match the user information, or cannot otherwise be verified, the entry is recorded in a predefined database, such as, a spam system database and the advertiser is not paid for the click. Additionally, in some embodiments, the user is presented a ‘dead page’ stating that the link was generated fraudulently.

A feature of preferred embodiments of the invention includes the dynamic generation of a confirmation code that comprises data that expires. An advantage to this feature is that the merchant placing the advertisement can verify the validity of the click on the advertisement by determining whether the confirmation code has expired. A further advantage to this feature is that an expired confirmation code alerts the merchant to potentially fraudulent activity and discourage illegal spamming.

Another feature of embodiments of the invention is that the confirmation code includes the advertiser's identification and a dynamically generated user identification code. An advantage to this feature is that the merchant can identify advertisers that generate fraudulent or suspect clicks.

A still further feature of embodiments of the invention is that requests for advertisements accompanied by expired confirmation codes are entered into a spam system database and the advertiser is not paid for the suspected click. An advantage to this feature is that incentive for the spamming as a method of advertising is virtually eliminated; thereby minimizing misperceptions that the merchant is engaging in unlawful conduct and/or conducting undesirable business practices. A further advantage to this feature is that the merchant is more fairly and appropriately paying for the advertising service that is being provided.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the present invention.

FIG. 2 is a representation of an authentication system in accordance with a preferred embodiment of the present invention.

FIG. 3 is a representation of a preferred embodiment of a data interface having a confirmation code contained therein.

FIG. 4 is a block schematic of a representation of a data authentication system in accordance with preferred embodiment of the present invention.

### DETAILED DESCRIPTION OF PREFERRED EMBODIMENTS

Embodiments of the present invention are directed to a system, method and apparatus for a data request and distribution authentication system. More specifically, the data authentication system couples a confirmation code with the distribution of data and compares the confirmation code to known data upon a response to the distributed data.

Hardware Environment:

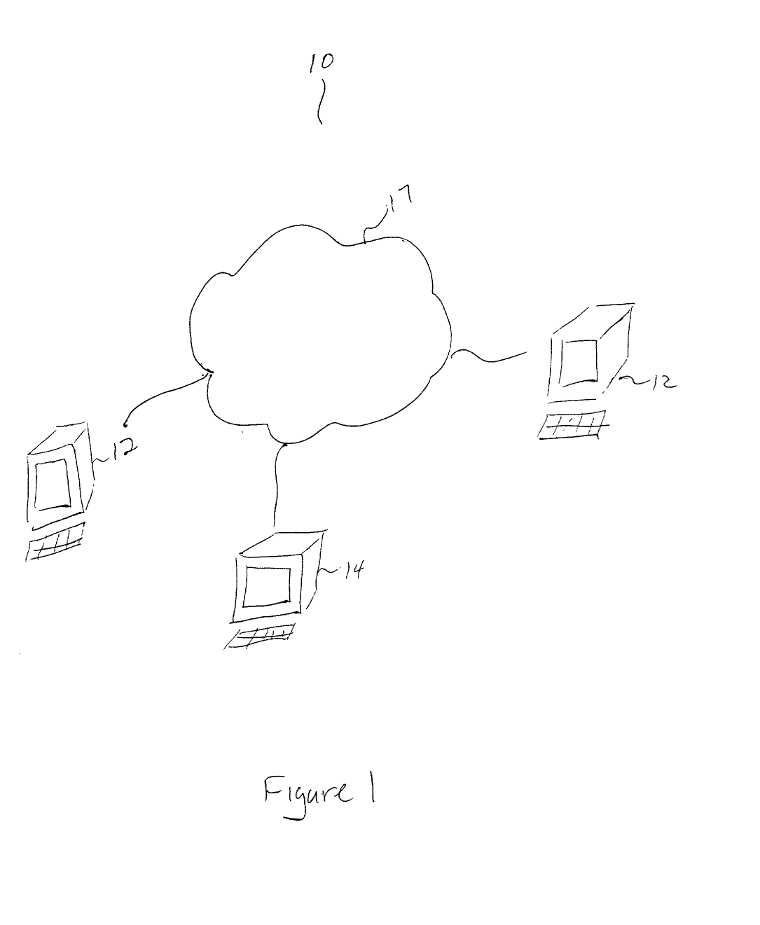

Preferred embodiments of the instant invention operate in concert with a plurality of networked computers, such as, for example, a user computer and a server computer which are coupled together on a communications network, such as, for example, the Internet or a wide area network. FIG. 1 depicts a network system 10 that operates in accordance with preferred embodiments of the invention. In preferred embodiments, the network system 10 includes a server 12, or a provider computer, a client, or user computer 14, wherein the server computer 12 and the user computer 14 are in electronic communication with each other via a communication link 17.

In some preferred embodiments, the network system 10 includes a plurality of either the server computer 12, the user computer 14, or any combination thereof. The server computer 12 contains a variety of data that is accessible by the user computer 14 or clients. The network 10 includes one or more (and preferably a plurality of) servers 12 that are operatively connected to the communication link 17. Two such servers 12 are shown in FIG. 1. It will be understood that network systems in accordance with further embodiments may include more than two servers 12, and in most instances, more than one user computer.

The provider computer 12, or server, may comprise any suitable network device capable of providing content (data representing text, hypertext, photographs, graphics video and/or audio) for communication over the network. In preferred embodiments, the provider computer 12 comprises a programmable processor capable of operating in accordance with programs stored on one or more computer readable media to provide content for communication to a user computer 14. The provider computer 12 may comprise, for example, but not limited to, a personal computer, a mainframe computer, network computer, portable computer, personal digital assistant (such as, a 3Com Palm Pilot), or the like.

In a preferred wide area network environment, such as, the Internet environment, the provider computer 12 is controlled by suitable software to respond to a valid request for content by providing (or downloading) data in the form of one or more HTML files to the user computer 14 from which the request was made. It will be understood by those skilled in the art that this process involves communications through suitable servers, routers and other components, as is dictated by the particular network environment. The communication link 17 may include a public network, such as the Internet, a local area network, or any other suitable communications connection, hardwired, wireless, or a hybrid thereof.

The user computer 14 may comprise any suitable network device capable of communicating with other network devices in the network system. In preferred embodiments, the user computer comprises a programmable processor, a display device, and a user input device. In one preferred embodiment, the user computer comprises a personal computer system having a CRT display, a keyboard and a mouse user-input device.

The user computer 14 is controlled by suitable software, including network communication and browser software to allow a user to request, receive and display information (or content) from or through a provider computer 12 on the network system 10. The user computers 14 are any means capable of communicating with the server computers 12, including, but not limited to, personal computers, stand alone media including hard drives, CD ROMs, DVD Roms, kiosks and ATM-type machines. The user computers 14 access the server computers 12 via the wide area network or through some other remote access, such as, for example, by telephone, facsimile, personal digital assistant, pulse code system, web TV, or any other device or method the communicates alpha numeric data with a server.

General Description of Preferred Embodiments:

Embodiments of the present invention are directed to a system, method and apparatus for a data request and distribution authentication system. More specifically, embodiments of the present invention are directed to a system for differentiating between fraudulently generated requests for information, such as, an advertisement, and requests for information resulting from genuine user interest.

As discussed above, embodiments of the authentication system operate in conjunction with a network of computers having at least one provider computer 12 and one user computer 14. Embodiments of the authentication system 20 comprise a provider computer 12, a data interface 22, a data interface provider computer 15, an identifying indicia generator 24 and a plurality of databases 36. The provider computer 12, such as a merchant computer, stores information that the data provider or merchant desires users to view. Typically, the information is directed to products or services offered by the merchant. To advertise or promote the products and services the merchant produces and/or hires a third party to produce data interface, such as advertisements for the information to be promoted. In another embodiment, such as an advertising service provider model, a merchant or business desirous of promotion contracts with an advertising company to display advertisements of the business. The advertising company displays or promotes the business in various types of media, including, but not limited to, web pages, email, hard print and the like. In this embodiment, the advertising company chooses the advertisement, the location and times to display the advertisements for the business.

The data interface 22 is any representation of, or any information directed to, a set of predefined data that the provider, such as, the merchant, desires a user to view. The predefined data can include any type of information, including, but not limited, to product or service information.

The data interface 22 can contain images, text, multi-media data, such as, commercial-type programming, video clips, any combinations thereof, and the like. The data interface 22 is designed to peak the interest of users, such as, consumers, such that, the user will respond and seek further information about the data, such as a product or service. In one preferred embodiment, the data interface is a banner advertisement that can be placed on a web page.

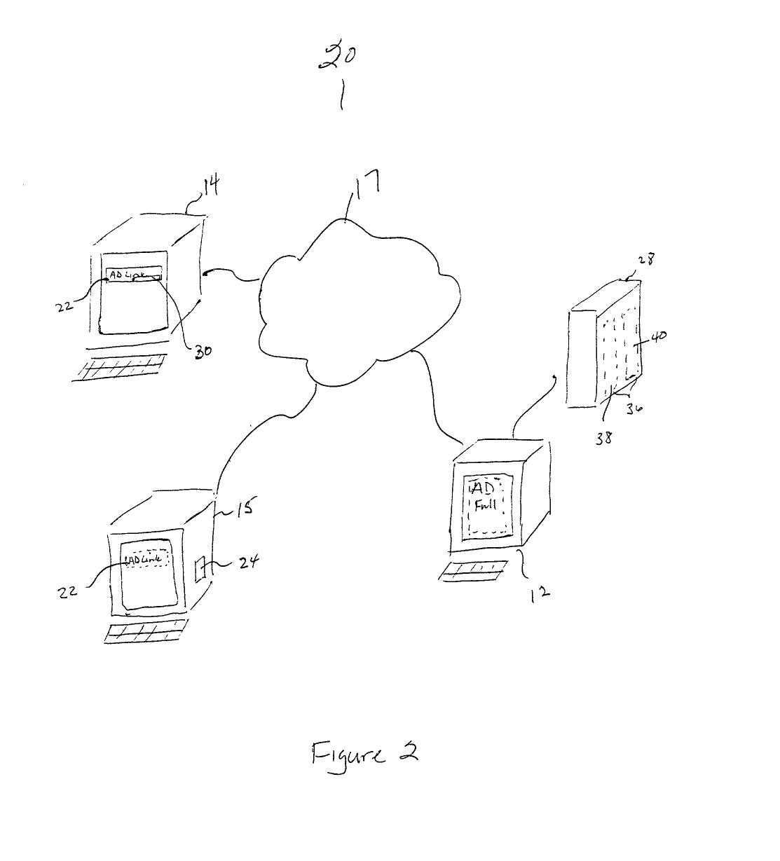

The data interface 22 is provided to the user by a data interface provider, such as, an advertiser or advertising agency. Although the data interfaces 22 can be stored on any computer, including the merchant's computer 12, with reference to FIG. 2, in one preferred embodiment, the data interfaces are stored on a data interface provider computer 15, wherein the data interface provider attracts users via various web pages or web sites that include the data interfaces, or advertisements. The data interface provider computer 15 operates in accordance with programs stored on one or more computer readable media to provide content for communication to a user computer 14, and further operates in accordance with standard transmission protocols for network computers.

Generally, although not in all instances, the data interface provider, for example, the advertiser, is not the provider of the predefined data, that is, the data interface provider is not the merchant. In preferred embodiments, the data interface provider is identified by a code or identification. Thus, in the instance of advertisers, an advertiser's identification code is assigned by the merchant to the advertiser such that the merchant can track the advertising results for each advertiser.

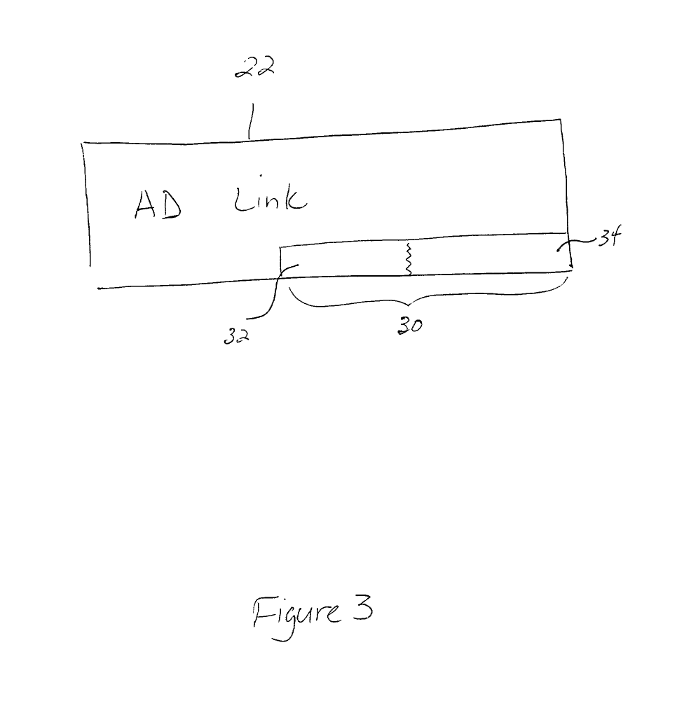

The identifying indicia generator 24 is software that is capable of operating in conjunction with a network of computers, on a stand alone computer, or any other suitable hardware. The identifying indicia generator 24 operates in conjunction with the data interface 22. In one preferred embodiment, the identifying indicia generator resides in the data interface provider computer 15. Upon the transfer of the data interface to a user's computer 14, the identifying indicia generator 24 generates identifying indicia 30. With reference to FIG. 3, the identifying indicia 30 is coupled to the data interface 22 that is loaded onto the user's computer 14 such that the particular dynamically generated data interface 22 can be associated with the specific user. In one preferred embodiment, the identifying indicia 30 is a confirmation code.

It is to be understood that the identifying indicia generator 24 can be any type of hardware or software that is configured to generate identifying indicia 30. For instance, in one embodiment, the identifying indicia generator 24 is a self-aware device that includes some type of unique identifier, such as for example, a network interface MAC address, or an embedded system identifier, wherein the self-aware device is capable of generating identifying indicia 30.

The identifying indicia 30 can comprise any type of predefined information that enables a merchant to associate a particular data interface, a user and a data interface provider. With reference to FIG. 3, in one preferred embodiment, the confirmation code comprises the advertiser's identification code 32 and a dynamically generated user identification code 34. As discussed above, the advertiser's identification code 32 is preassigned by the merchant and is associated with each advertisement or advertising link that the advertiser utilizes.

The dynamically generated user identification code 34 can be any indicia which uniquely identifies the user and can be verified by the merchant. The identifying indicia generator 24 generates the user identification at the time that the advertisement or link is displayed, or loaded onto the user's computer 14, for instance, at the time that the advertisement or link is generated on a user's web page. In one preferred embodiment, the user identification comprises the user's IP address, wherein the IP address is derived via standard transmission protocols. In other embodiments, the user identification code 34 can be a time stamp, or any combination, including, but not limited to, a user IP address and a time stamp.

Regardless of the actual data contained within the user identification code 34, in preferred embodiments, the dynamically generated user identification code 34 is coupled to, or encrypted into, the advertiser identification code 32 via the identifying indicia generator 24. The combined user identification code 34 and advertiser code 32 creates the confirmation code. If the user identification code is encrypted into an advertiser's identification, a confirmation code in the form of an encrypted advertiser's identification is created. Thus, when the user is transmitted to the merchant's web page, where the full advertisement or sales page resides, the advertiser's identification code 32 and user identification code 34 is transmitted to the merchant with the request for the advertisement.

As stated above, any indicia that can be verified by the merchant can be used to generate the user identification code 34. However, to further protect the user identification code, the user identification code 34 can be encrypted. In one embodiment, the “seed” utilized to encrypt the code is manufactured by an independent third party or provider on a random or periodic basis. The new seed is transmitted to the merchant and the advertiser, such that encryption of a user's identification code can be updated. In other preferred embodiments, MD5, DES or EDES encryption is used to encrypt the data, although any method or process capable of encrypting the data is suitable.

The plurality of databases 36 resides in the provider computer 12 or is coupled thereto on a storage medium 28. The plurality of databases 36 comprises a valid response database 38 and a invalid response database 40. The valid response database 38 represents fees owed to various advertisers for authentic or legitimate clicks, or genuine interest in the advertised data. In contrast, the invalid response database 40 represents clicks on advertisements that are deemed to be generated fraudulently. The advertiser's code 32 is recorded in this database in conjunction with the specific advertisement. In this manner, the merchant can monitor a particular advertiser to determine whether the advertiser is inappropriately marketing the product or service.

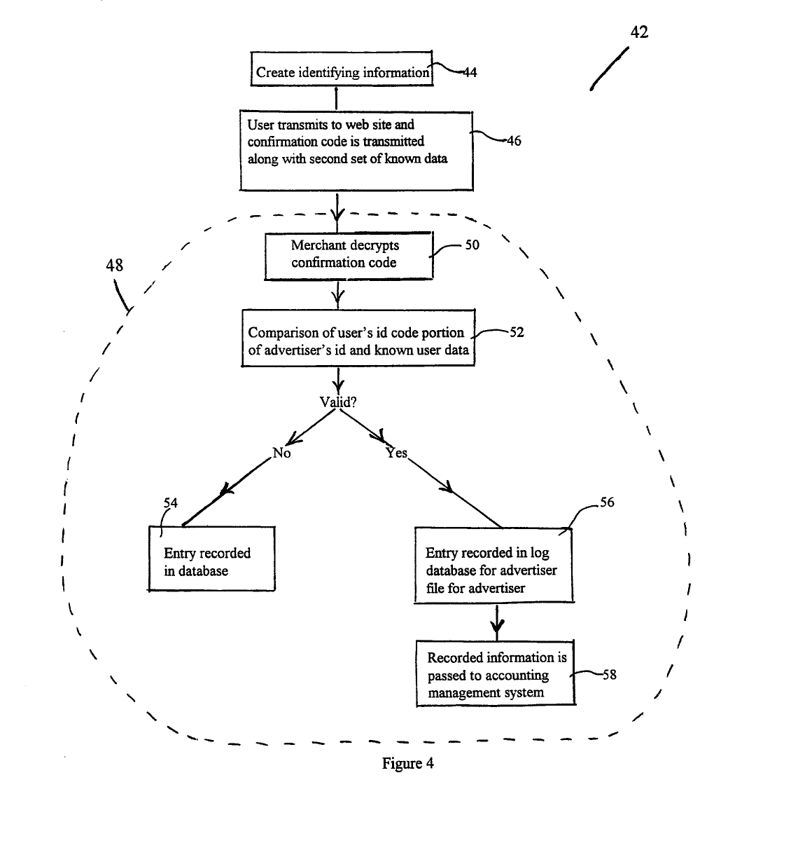

Overall, preferred embodiments of the method of authenticating requests for advertisements, or responses thereto, operates, in part, via dynamic generation of information upon the presentation of information to users and the dynamic generation of new, but similar, information upon the user's request for the data. To validate a user's response, the two information sets are compared in total, or in part. With reference to FIG. 4, embodiments of a method for authenticating responses or requests for data 42, such as an advertisement, comprises creating identifying indicia 44, receiving a request for data 46, and determining the authenticity of the data request 48.

As discussed above, upon the presentation of a banner advertisement or other data interface to a user, identifying indicia is created 44, wherein the identifying indicia is associated with the specific advertisement link. In preferred embodiments, the identifying indicia 22 includes information pertaining to the advertiser and the user receiving the advertisement link.

If the user chooses to view the full advertisement or sales page, the user clicks onto the link and is transmitted to the merchant's web site. Upon the transfer of a user to the merchant's web site containing the advertisement, the identifying indicia, that is the confirmation code, is transmitted therewith 46. In addition, a second set of known user data is forwarded to the merchant. The second set of known user data is generated in accordance with standard transmission protocol and represents the most current user information. In one preferred embodiment, the known user data identifies the user's IP address, although any other type of data that can be used to identify the user, including, but not limited to, a time stamp, cookie, date and time stamp, or any combination thereof.

Upon receipt of the confirmation code and the second set of known user data, the authenticity of the data request is determined 48. To determine the authenticity of the request, the merchant decrypts the confirmation code 50, that is, the user identification is extracted from the advertiser's identification. A comparison is then made between the user's identification portion of the confirmation code and the second set of known user data 52, that is, the known data, such as, the known IP address of the user or the time of transmission to the merchant's web site.

Once a comparison is made to determine the validity or authenticity of the request, the results are recorded in an appropriate database. If the encrypted advertiser's identification is not valid, that is, the user identification code does not match the known data, or is beyond an acceptable threshold tolerance, for example, a predetermined time period, the entry is recorded in a predefined database, such as, an invalid response or a spam system database 54. If the advertiser's identification is valid, the entry is recorded in a logging database file for the particular advertiser 56. Once the information is recorded in the advertiser's log, the entry is further passed to an accounting management system 58, which tracks the amount of remuneration owed to each advertiser.

As illustrated in the embodiments discussed above, the use of verifiable information to create the identifying indicia allows the merchant an easy mechanism by which to verify the request. Indeed, the use of automatically transferred standard transmission protocol information with the request assures the merchant of accuracy in assessing the validity of the request, as the merchant is able to compare standard protocol information, such as, the user IP address, and the user identification contained within the confirmation code. As discussed above, if the user identification and the IP address match, the merchant can verify that the click on the advertisement is valid.

As is commonly understood, information that is copied from one web page to another, or to an email, is not subject to the standard transmission protocols due to the nature of the copy function. Thus, a link that is copied into email will reflect a user identification that contains information that is either, not relevant to the email recipient, or it may reflect information relevant to the location from which the link was copied. As no new confirmation code is generated during the copy from the original location, the copied link in the email is static. Thus, when the email is opened and the advertisement or link is clicked on by the “true” user, the confirmation code containing the user code will reflect stale information that was generated prior to the time the advertisement or link was copied into the email.

Similarly, if a time stamp is appended to the advertiser's identification, the merchant can then compare the actual time that the request is received at the merchant web site with the user's identification code, that is, the time stamp, as encrypted into the confirmation code. In this manner, the merchant can ascertain the length of time between the presentation of the advertisement link to the user and the response of the user, for example, the click by the user on the advertising link and the transmission of the request to the merchant's site. Thus, email transmissions of the advertisement would, in most instances, include a time stamp that reflects an unusual length of time between the presentation of the advertising link and the response to the advertisement.

It is to be understood that variations of this type of verifiable data can be used and is not limited to data generated via standard transmission. Indeed, additional dynamic generation software can be included in embodiments, such that other types of information can be transmitted with the request including, but not limited to, images, digital signature and the like.

Although the foregoing describes the invention in accordance with various illustrated and described embodiments, it is not intended to limit the invention. Rather, the foregoing is intended to cover all modifications an alternative constructions falling within the spirit and scope of the invention as expressed in the appended claims.

What is claimed is:

1. A method for authenticating a request for data on a network having at least one user computer and one provider computer, wherein the request for data is preceded by the distribution of a data interface to the user computer from a data interface provider, comprising:
creating identifying indicia upon the transmission of the data interface to the user computer, wherein the identifying indicia comprises a first user code;
associating the identifying indicia with the data interface;
transmitting a request from the user computer for the data identified in the data interface to the provider computer;
transmitting a second user code to the provider computer from the user computer;
transmitting the identifying indicia to the provider computer; and
determining the authenticity of the data request from the user.

2. A method as claimed in claim 1, wherein determining the authenticity of the data request further comprises comparing the identifying indicia and second user code.

3. A method as claimed in claim 1, further comprising assigning a provider interface code to the data interface provider.

4. A method as claimed in claim 3, wherein the creating of the identifying indicia comprises dynamically generating the first user code and combining the first user code and provider interface code.

5. A method as claimed in claim 1, wherein the user computer and provider computers operate in accordance with transmission protocols,
and further comprising dynamically generating the second user code via the transmission protocols.

6. A method as claimed in claim 1, further comprising:
comparing, on the provider computer, a portion of the identifying indicia with the second user code to determine a degree of match; and
providing, from the provider computer, information regarding the degree of match determined by comparing the portion of the identifying indicia and second user code.

7. A system for authenticating a request for data on a network having at least one user computer and one data provider computer, wherein the request for data is preceded by the distribution of a data interface to the user computer from a data interface provider, comprising:
a data interface provider computer, wherein the data interface provider computer provides the data interface to the user's computer;
an identifying indicia generator; and
a plurality of databases; and
wherein the identifying indicia generator generates a confirmation code comprising:
a first user code, wherein the first user code is dynamically generated upon the transmission of the data interface to the user computer; and
a data interface provider code, wherein the data interface provider code is preassigned to the data interface provider.

8. A system as claimed in 7, further comprising means for comparing the first user code and a second user code, wherein the second user code is dynamically generated by the user computer.

9. A method for authenticating the distribution of an advertisement for data and a request for the data in response to the advertisement on a network having at least one user computer and one provider computer, wherein the response to the advertisement is preceded by the distribution of the advertisement to the user computer from an advertiser, comprising:
creating a confirmation code upon the transmission of the advertisement to the user computer; wherein the confirmation code comprises a first user code;
associating the confirmation code with the advertisement;
transmitting a request from the user computer for the data identified in the advertisement to the provider computer;
transmitting a second user code generated by the transmission protocols to the provider computer;
transmitting the confirmation code to the provider computer;
determining the authenticity of the data request from the user.

10. A method as claimed in claim 9, wherein determining the authenticity of the data request further comprises comparing a portion of the identifying indicia and the second user code.

11. A method as claimed in claim 9, further comprising assigning an advertiser code to an advertiser.

12. A method as claimed in 11, wherein the creating of a confirmation code comprises dynamically generating the first user code and combining the first user code and advertiser code.

13. A method as claimed in 11, further comprising storing the advertiser code in a database in association with the advertiser.
